(19) United States
(12) Patent Application Publication
(10) Pub. No.: US 2012/0240220 A1
(43) Pub. Date: Sep. 20, 2012

(54) METHOD AND SYSTEM FOR CONTROLLING DATA ACCESS ON USER INTERFACES

(75) Inventor: Timothy D. Smith, Vienna, VA (US)

(73) Assignee: Raytheon Company, Waltham, MA (US)

(21) Appl. No.: 13/048,341

(22) Filed: Mar. 15, 2011

(51) Int. Cl. G06F 21/00

(52) U.S. Cl. 726/17

(57) ABSTRACT

A system for controlling access to data at the user interface level includes a device permissions manager to manage user access to data on a device including a device permissions comparator configured to receive a plurality of user profiles corresponding to users in proximity to the device and including user permissions to the data, and to generate a comparison of the user permissions. The device permissions manager also includes a device access controller configured to control access to the data on the device in response to the comparison of the user permissions.

### FIELD OF THE INVENTION

The inventive concepts, systems, and techniques described herein are directed to controlling data access on a user interface and, more particularly, to controlling data access based on user permissions to the data and proximity to the user interface.

### BACKGROUND

Current data access control schemes rely on the honor system to protect sensitive data and to prevent unauthorized access to data. Even with strong security measures in place, there is always a risk that an unauthorized user may come into contact with the data once another user accesses the data on a device (e.g., an unauthorized user may catch a glimpse of data on a display screen). Risk of unintended, undesirable, or uncontrollable data exposure may be heightened in facilities shared by multiple organizations in which members of one organization may be exposed to sensitive data from another organization. Unintended data exposure may also occur within the same organization when employees shielded from certain sensitive client matters nevertheless come into contact with client data, for example, while walking past a fellow employee's computer screen.

In a military setting, for example, coalition members who co-occupy command centers may be exposed to each other's sensitive, classified information. Similar circumstances may occur on naval vessels on which passengers may be unintentionally exposed to sensitive data, for example, while on the bridge. Because of these uncontrollable risks, military organizations may have no choice but to grant what essentially amounts to top security clearances to those who share their facilities but don't necessarily meet security standards and protocols.

In non-military settings, hospitals, courts, law firms, accounting firms, banks and other organizations often implement security measures to control data access. For example, many organizations implement information barriers such as a firewall to protect sensitive client information. However, firewalls and other conventional methods for protecting data (e.g., password protection at the computer systems level and/or data object privileges at the data object level) may not be able to prevent unintended or undesirable exposure to data once the data is available on a device that may be accessed by an unauthorized user. There exists, therefore, a long felt, unmet need to address these vulnerabilities.

### SUMMARY OF THE INVENTION

In general overview, the concepts, systems, and techniques described herein enable a device permissions manager to control access to data on a user interface device. The device permissions manager generates a comparison of user permissions to access data, the result of which is used to enable and/or disable data access on a user interface device. The user permissions correspond to users in proximity to the device. Such proximity may be based on different man-machine interface factors such as viewing distance from a display device, display screen size, room lighting, font size, etc. For example, a projector may project a relatively large user interface window on a pull down screen, in which case proximity to the user interface window may be expressed in dozens, or even hundreds of feet, whereas a small hand-held device may render a relatively small user interface window on a small screen, in which case proximity to the user interface window may be expressed in inches or a few feet.

Data access on a user interface device is based on a comparison of user permissions for users proximate to device. In a non-limiting example, the comparison includes an OR operation of binary user permissions values. For example, if a first user has permission to view the data (in which case user permissions for first user may be equal to 1) and a second user does not have permission to view the data (in which case user permissions for the second user may be equal to 0), an OR operation of the first and second permissions value yields 0, and so data access may be disabled (or not enabled) on the device. In this way, it can be seen that data access on the device will be based on the lowest permission value (which may be described as the “least common denominator” of permissions) of proximate users.

Advantageously, the inventive concepts, systems, and techniques enable data access protection at the user interface level. Data access is enabled and/or disabled based on permissions of users who come into contact with a particular user interface. Furthermore, data access may be granted to a particular user on a user interface device only if other users proximate to the device can also access the data. In some embodiments, the system may direct a user to a particular user interface device away from others who are not permitted to view data. This can be particularly beneficial to a group of organizations (for example, a military coalition, a partnership of business entities or even users of an organization with different security clearances) which collaborate with each other and cohabitate facilities but must nevertheless grant access to certain types of data to only a subset of users.

As by way of a non-limiting example, only high-ranking members of a first country's military can view field positions of special operations units. The high-ranking members may be able to view such positions on a computer terminal in a shared facility up until a member of another country's military (who is trusted but not privileged to view certain information) is within (or moves within) viewing range of the information on the computer terminal. Here, a device permissions manager generates a comparison of the user permissions and determines that not all users are able to access the privileged information and so disables this information on the computer terminal (e.g., by removing the information from the computer terminal). Such a scenario may arise in a variety of environments, for example, in a coalition command center and/or on military craft with passengers from multiple countries, at a law firm, or in a hospital.

The inventive concepts, systems, and techniques are not limited to enabling and/or disable data access, but can also be applied to enable and/or disable some or all user interface components in a user interface environment, such as a cockpit of an aircraft. In a particular example, a device permissions manager may activate and/or deactivate a cockpit of an aircraft based on the proximate pilot's flight experience, flight certifications, and/or access privileges. In this way, the aircraft may be protected from unauthorized access and flight safety may be enhanced by activating instrumentation only in the presence of experienced and qualified pilots.

In some embodiments, a device permissions manager receives tracking information about a particular user and enables data access to the user's privileged data (which may include data needed or desired to perform certain tasks) on user interface devices proximate to the user. For example, the device permissions manager may enable data access when the user enters an interface zone about a device (and disables data access when the user exits the interface zone about the device). Moreover, data access is modified based on data access permissions of other users who may enter or exit the interface zone.

In other embodiments, user interface zones are defined relative to each user's location. In a particular non-limiting example, a user interface zone may be centered on a user's location and extend radially in all directions about the user based on man-machine interface factors. The radial extent of a user interface zone may depend on text readability on a screen (and/or the readability of pictorial information), audibility of sound played on a speaker, and/or type of input device (e.g., a mouse and keyboard). Usable distance may depend on user interface properties such as screen size, font size, sound volume, and even direction of an interface relative to a user.

In one aspect, a system includes a device permissions manager to manage user access to data on a device, including a device permissions comparator configured to receive a plurality of user profiles, each user profile corresponding to a user in proximity to the device and including user permissions to the data, and to generate a comparison of the user permissions, and a device access controller configured to control access to the data on the device in response to the comparison of the user permissions.

In further embodiments, the system includes one or more of the following features: user proximity to the device corresponds to users located within an interface zone about the device; the device permissions manager is configured to receive user profile updates based on a predetermined condition corresponding to at least one of a user entering the interface zone about the device or a user exiting the interface zone about the device; user proximity to the device corresponds to the device being located within at least one interface zone defined about each; the device permissions manager is configured to receive user profile updates based on a predetermined condition corresponding to a device location relative to the at least one interface zone; the device includes a plurality of devices; the plurality of devices is located in a predetermined location; the plurality of devices is associated with a predetermined device type, and; the device permissions manager is unable to extract user identification information from the plurality of user profiles.

In another aspect, a method for controlling data access on a device includes receiving a plurality of user profiles, each user profile corresponding to a user in proximity to a device and including user permissions to data, generating a comparison of user permissions to determine data access on the device, and, in response to the comparison of user permissions, controlling access to data on the device.

In further embodiments, the method includes one or more of the following features: determining user proximity to the device based on users located within an interface zone about the device; receiving user profile updates based on a predetermined condition corresponding to at least one of a user entering the interface zone about the device or a user exiting the interface zone about the device; determining user proximity to the device based on the device being located within interface zones defined about each user, and; receiving user profile updates based on a predetermined condition corresponding to a device location relative to at least one of the interface zones.

In another aspect, a computer readable medium has encoded thereon software for controlling access to data, said software including instructions for receiving a plurality of user profiles, each user profile corresponding to a user in proximity to a device and including user permissions to data, generating a comparison of user permissions to determine data access on the device, and, in response to the comparison of user permissions, controlling access to data on the device.

In further embodiments, said software further includes instructions for one or more of the following features: determining user proximity to the device based on users located within an interface zone about the device; receiving user profile updates based on a predetermined condition corresponding to at least one of a user entering the interface zone about the device or a user exiting the interface zone about the device; determining user proximity to the device based on the device being located within interface zones defined about each user, and; receiving user profile updates based on a predetermined condition corresponding to a device location relative to at least one of the interface zones.

### BRIEF DESCRIPTION OF THE DRAWINGS

The foregoing features of the concepts, systems, and techniques described herein may be more fully understood from the following description of the drawings in which:

FIG. 1 is a block diagram of an embodiment of a system to control data access on a device based on user permissions and user proximity to the device;

FIG. 2 is a block diagram of databases suitable for use with an embodiment of the invention;

FIG. 3A is a pictorial representation of an embodiment of an interface zone defined about a device;

FIG. 3B is a pictorial representation of another embodiment of an interface zone defined about another device;

FIG. 3C is a pictorial representation of an embodiment of an interface zone defined about a user;

FIGS. 4A and 4B include a timeline and top view of an environment which illustrate an operation of an embodiment of a system to control data access on user interface devices.

FIG. 5 is a diagram showing an exemplary client-server environment suitable for use with embodiments of the invention;

FIG. 6 is a flow diagram of an embodiment of a method for controlling data access on a device; and

FIG. 7 is a diagram showing an exemplary hardware and operating environment of a suitable computer for use with embodiments of the invention.

### DETAILED DESCRIPTION

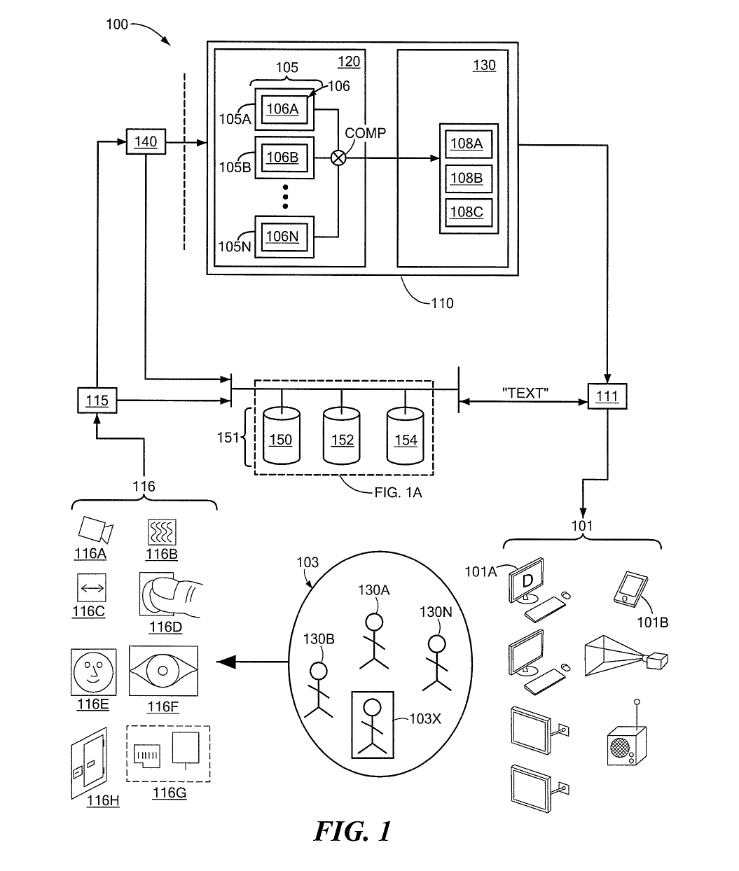

Referring to FIG. 1, in one aspect, system 100 includes device permissions manager 110 to manage user access to data on one or more user interface devices (generally designated by reference number 101 and hereinafter referred to as “devices”). Device permissions manager 110 includes device permissions comparator 120 configured to receive plurality of user profiles (generally designated by reference numeral 105), each user profile corresponding to a user (e.g., first user 103A, second user 103B, etc. up to N^{th} user 103N) in proximity to one or more devices 101 and including user permissions (generally designated by reference numeral 106) to data. Device permissions comparator 120 is also configured to generate comparison (denoted as COMP in FIG. 1) of user permissions 106. Device permissions manager 110 also includes device access controller 130 configured to control access to data on at least one of the devices 101 in response to comparison COMP of user permissions 106.

In response to comparison COMP of user permissions 106, device access controller 130 controls devices 101, which includes, but is not limited to, enabling access to data on devices 101 (for example, data designated by “D” on particular device 101A) or disabling access to data on devices 101. In further embodiments, device access controller 130 renders commands to gateway device 111 and gateway device 111 enables or disables data access on devices 101. Gateway device 111 may include a device manager which controls devices 101. Advantageously, gateway device 111 can aid in centralizing device control and can thwart or eliminate efforts by unauthorized users to gain access to data by tampering with devices 101.

In some embodiments, gateway device 111 can enable access to devices 101 in a predetermined location including, but not limited to, a meeting room, an aircraft cockpit, a control room, etc. In the same or different embodiment, gateway device 111 controls access to a predetermined type of device, such display devices, input devices, pointing devices, etc. In some embodiments, device access controller 130 controls devices 101 on a particular workstation, including a workstation displayer device, a workstation mouse-input device, and/or a work station keyboard device. Such features advantageously allow the device access controller 130 to limit the type of data access, such as view-only access.

In a further embodiment, device permissions comparator 120 receives user profiles 105 (e.g., first user profile 105A, second user profile 105B, etc., up to N^{th} user profile 105N) from user information manager 140. Each user profile 105A-105N includes user permissions 106A-106N to denote whether or not users 103 can access the data on devices 101. The data includes most any type of data that is desired, needed, or necessary for users 103 to perform certain tasks. For example, the data may include (although is not limited to) one or more of alpha-numeric information, audio information, and/or video information. The information may include audio clips and samples (e.g., audio streams, sonar samples), video files (such as video messages, video conferencing data streams, etc.), and location information (such as latitude/longitude coordinates on a map, points-of-interest, etc.).

User permissions 106A-106N may include different types of information, such as binary information, integers, categorical information, etc. For example, user permissions 106A-106N may include binary values (i.e., a 0 or a 1, TRUE or FALSE, etc.) corresponding to whether or not a user can access the data. In some embodiments, user permissions 106A-106N can include a range of values (for example, 1-5) to denote data access levels, or a list of categories (for example, HIGH, MEDIUM, LOW) corresponding to security clearances necessary for viewing the data.

The device permissions comparator 120 generates comparison COMP of user permissions 106 to determine whether or not data can be accessed on devices 101. In a particular non-limiting example, the device permissions comparator 120 can perform an OR operation on binary values corresponding to user permissions for users 103 proximate to devices 101. In another non-limiting example, the device permissions comparator 120 can perform a search for particular user permissions value signifying that at least one of the users is unable to access the data.

In some embodiments, device permissions comparator 120 receives user profiles 105A-105N from user information manager 140. Optionally, user information manager 140 removes any information from user profiles 105 which may be used to identify users 101. In other words, user profiles 105 include only the information needed to determine whether or not data is accessible on devices 101 (in particular, user permissions 105) so that users 103 remain anonymous. Advantageously, such features can help reduce and/or minimize privacy concerns associated with tracking user positions and/or help maintain user safety by keeping user identity private and secure.

User information manager 140 may be coupled to receive user tracking information from user tracking system 115. User tracking system 115 is configured to receive user location and identification information from one or more sensors, location tracking devices, and/or user identification devices (generally designated by reference numeral 116). For example, the user tracking system 115 may receive information from camera tracking and video processing sensors 116A, heat sensors 116B, movement sensors 116B, biometric sensors (including, but not limited to, finger print readers 116D, face recognition readers 116E, and iris readers 116F), tag-based radio frequency identification systems 116G, etc. In some instances, users 103 may provide (or reveal) their location by requesting and gaining access to a particular room through a doorway 116H in a tracked environment.

In another embodiment, device access controller 130 controls access to data on devices 101 in response to comparison COMP of user permissions 106 by rendering control information 108 including, but not limited to, device identifier 108A (to uniquely identify a particular device), data identifier 108B (to uniquely identify a data entity), and command value 108C (to generate a command). Gateway device 111 receives command information 108 and performs functions on one or more devices 101 based on command information parameters (i.e., 108A-108C). In a particular example, device access controller 130 renders command information 108 to a particular device (e.g., device 101A) and a particular data entity (e.g., “TEXT”), along with an associated command. More particularly, command value 108C can include a code value from a predefined set of codes to perform various functions, such as to enable data access, disable access, etc. In other embodiments, command value 108C includes a command string, such as “ENABLE” and/or “DISABLE.” Optionally, gateway device 111 receives command information 108 and performs the command. For example, gateway device 111 may request data “TEXT” from a data source and route data “TEXT” to device 101A along with a command to enable display of data “TEXT.” Device 101A receives data “TEXT” and displays data “TEXT” so that users 103 may consume data “TEXT.”

In a further embodiment, user profiles 105 include a device identifier to uniquely identify a device and a data identifier to uniquely identify a data entity. Device permissions comparator 120 segregates user profiles 105 by device identifier and by data identifier, and compares user permissions 106 for each device identifier/data identifier pairing. Device access controller 130 renders command information 108 based on comparisons for each device identifier/data identifier pairing.

In some embodiments, user information manager 140 receives a list of one or more users (e.g., a list of user identifiers to uniquely identify each user) and location information for each user. User information manager 140 determines which devices 101 (if any) a user is proximate to and/or receives such proximity information from user tracking system 115. In these embodiments, user information manager 140 may authenticate users 101 by cross-checking user identification information with user attributes obtained from sensors 116 (e.g., facial scans, fingerprint scans, radio frequency identification tag numbers, etc.) to validate users 103. Optionally, if user information manager 140 is unable to identify one or more users (an example of such a user is designated by reference numeral 103X), then device permissions manager disables all data access on devices 101 proximate to unidentified user 103X.

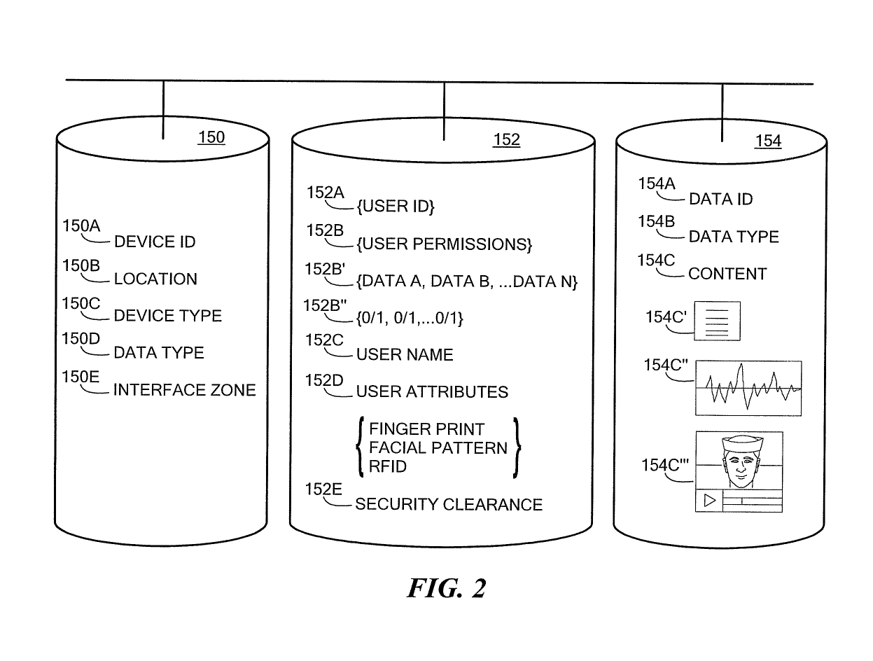

Referring now to FIG. 2 and again to FIG. 1, in some embodiments user information manager 140 (or user tracking system 115) requests information associated with users 103, devices 101, and the data from one or more databases 151 including, but not limited to, device database 150, user database 152, and information database 154. More particularly, user information manager 140 may request device information from a device database 150 including, but not limited to, device identifier 150A (to uniquely identify devices 101), device location 150B (including, but not limited to, a room number, a coordinate on a map, etc., to identify device location), device type 150C (including, but not limited to, command console, overhead monitor, projection station, hand-held device, radio, etc.), and data types 150D (to identify the type of data accessed on devices 101), and/or device interface zone 150E (to define a volume or zone about a device based on whether or not users 103 are able to hear, see, edit, etc. data accessed on the device).

In some instances, information in device database 150 is predetermined based on devices 101 located in a particular facility, although devices may be dynamically updated (e.g., inserted into or deleted from device database 150) based on, for example, users 103 carrying devices 101 (such as a portable device 101B) into or out of a facility. It should be noted, however, that devices 101 may not be limited to those within an existing facility. For example, devices 101 may be predefined as part of a general device taxonomy or all known manufactured devices (e.g., all known instances of a communications device issued by the military). Furthermore, devices may include those in a particular location, such as a meeting room, and/or a particular environment, such as a cockpit in an aircraft.

User information manager 140 may request user information from user database 152 including, but not limited to, user identifier 152A (to uniquely identifier users 103) and user permissions information 152B (to define user data access permissions for one or more data entities). More particularly, user permissions 152B may be stored as list of data accessibility values 152B′ for successive data entities. Data accessibility value 152B′ are associated with the user permissions 106 and may include data values 152B″ such as binary values (e.g., a 0 or a 1), a range of values, categorical information, etc. to denote whether or not users 103 can access data.

User database 152 may also include user name 152C and user attributes 152D to authenticate and validate users 103. For example, user attributes 152D can include one or more of the following: finger print records, facial patterns, and radio frequency tag identification numbers, etc. User database 152 may also include general security clearances 152E which may be used to override any particular user permissions settings so that device access controller 130 can control data access by, for example, room number, certain types of tasks, operational status, etc.

User information manager 140 may request data information from information database 154 including, but not limited to, data identifier 154A (to uniquely identify a data entity), data type 154B (to indicate the type and/or format of the data such as, binary, decimal, integer, real number, memory reference, etc.), and data content 154C, for example, a text file 154C′, audio sample 154C″, video sample154C′″, data stored in extensible markup language (XML) format, etc.

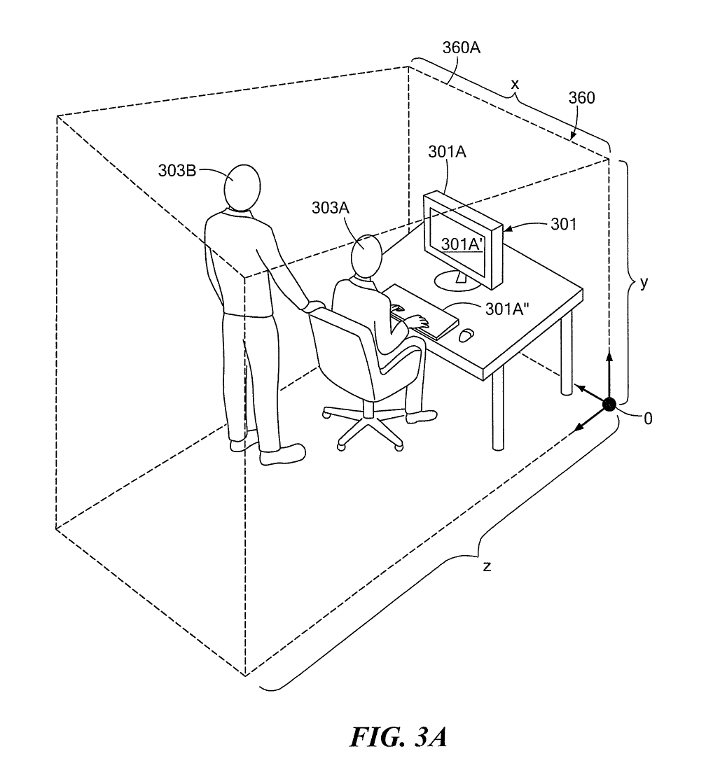

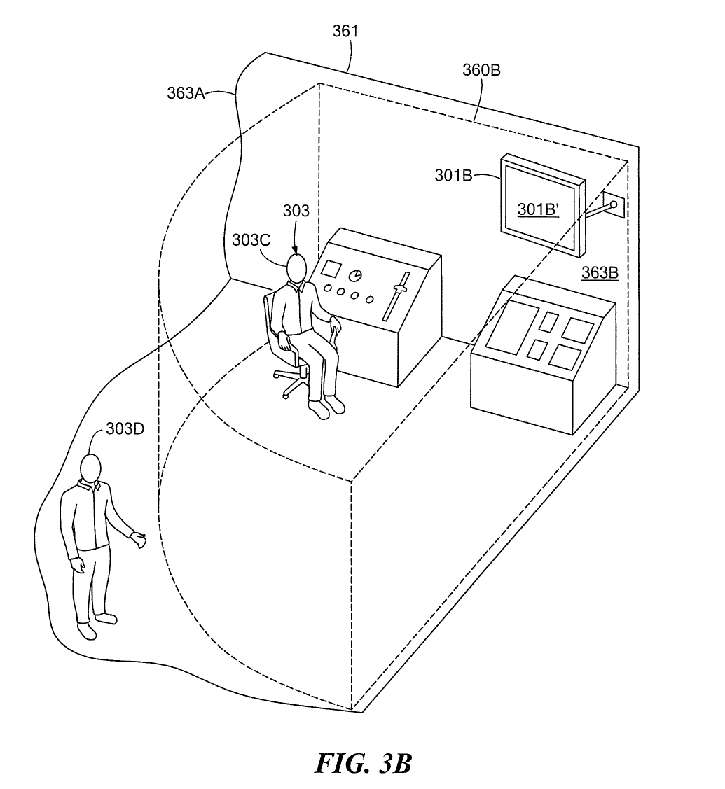

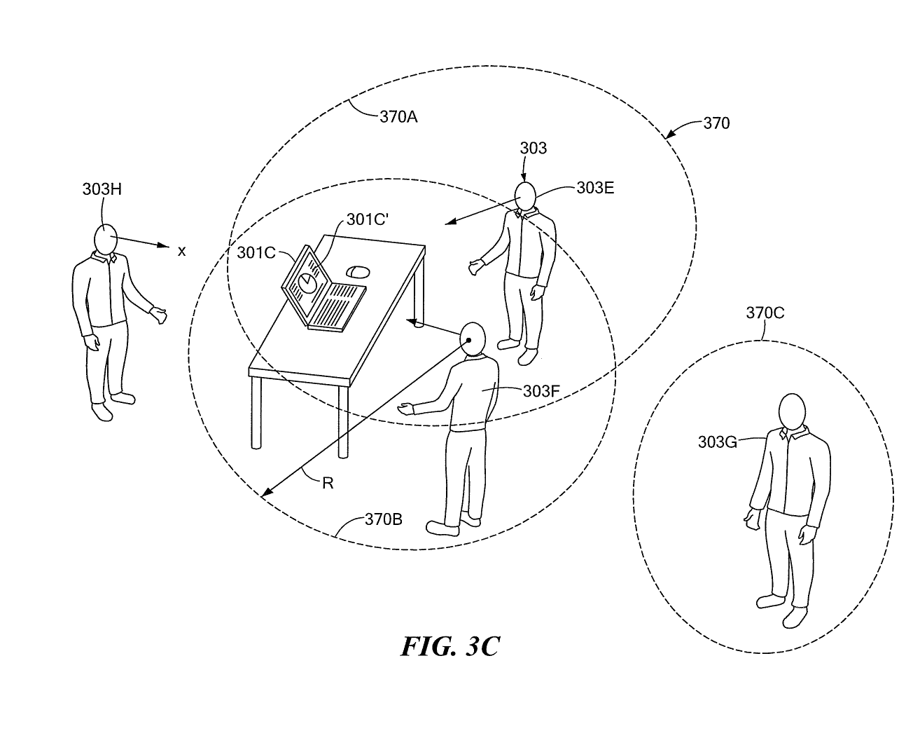

Referring now to FIGS. 3A and 3B, in a further embodiment the inventive concepts, systems, and techniques described herein include interface zones 360 defined about devices 301 to aid in determining whether or not users 303 are proximate to devices 301. In the particular examples shown in FIGS. 3A and 3B, first interface zone 360A is defined about device 301A and second interface zone 360B is defined about device 301B. Interface zones 360A, 360B define volumes surrounding respective devices 301A, 301B and more particularly spatial volumes within which users 303 may access data on devices 301. Such volumes may be defined by origin O, first dimension X defining a horizontal extent of the volume, second dimension Y defining a vertical extent of the volume, and third dimension Z defining a depth extent of the volume.

Data access may be determined based on a variety human factors including, but not limited to, a data type (such as text, audio/video, etc.) and a data interaction (such as visual data, audio data, edited data, etc.). For example, human factors such as font size, screen size, and/or input device (such as a keyboard and a mouse) determine access and interactive aspects of text which may be displayed and/or edited. Interface zone 360A defined about device 301A (here, a computer) includes a spatial volume within which text data is legible to users 303 when displayed on device display screen 301A′ and in which text data may be edited using keyboard and mouse 301A″.

As can be seen in FIGS. 3A and 3B, first user 303A located within interface zone 360A (and more particularly, seated in a chair facing device 301A) can view and edit text data on device 301A. Second user 303B located within interface zone 360A (and more particularly, looking over user's (303A) shoulder) can view data on device 301A, but cannot edit data. A third user 303B located within interface 360B (and more particularly, seated at a command console in room 361) can view data on device 301B, however, fourth user 303D standing in room 351 outside interface zone 360B cannot view data on device 301B.

Generally, device type and device interaction will determine the spatial dimensions of interface zones 360. For example, because device 301A is desktop computer, interface zone 360A is relatively small (i.e., relatively close to the desktop computer) whereas because device 301B is an overhead display (i.e., a large, high-mounted display), interface zone 360B is relatively large.

It will be understood that other factors may contribute to dimensions and shapes of interface zones 360, for example, as can be seen in FIG. 3B, walls 363A, 363B of room 361 limit extent of interface zone 360B.

Referring now to FIG. 3C, in which like elements to FIGS. 3A and 3B are designated by like reference numerals, interface zones 370 are defined about users 303. A first interface zone 370A is defined about user 303E and second interface zone 370B is defined about user 303F. Interface zones 370A, 370B include volumes which may be centered about locations of respective users 303E, 303F. Such volumes may be defined by a sphere (or at least a portion of a sphere) having a radius R defining an extent to which users 303 are able to, for example, read text on a screen, hear audio samples from a speaker, touch and use input devices, etc. As can be seen in FIG. 3C, device 301C (a laptop computer) is within user interface zones 370A, 370B of users 303E, 303F. This means that users 370A, 370B are able to read text on screen 301C′. However, device 301C is outside user interface zone 370C of user 303G and so user 303G is unable to read text on screen 301C′. Although user 303H is relatively close to device 301C, user 303H is unable to read text on screen 301C′ because device 301C is facing the opposite direction.

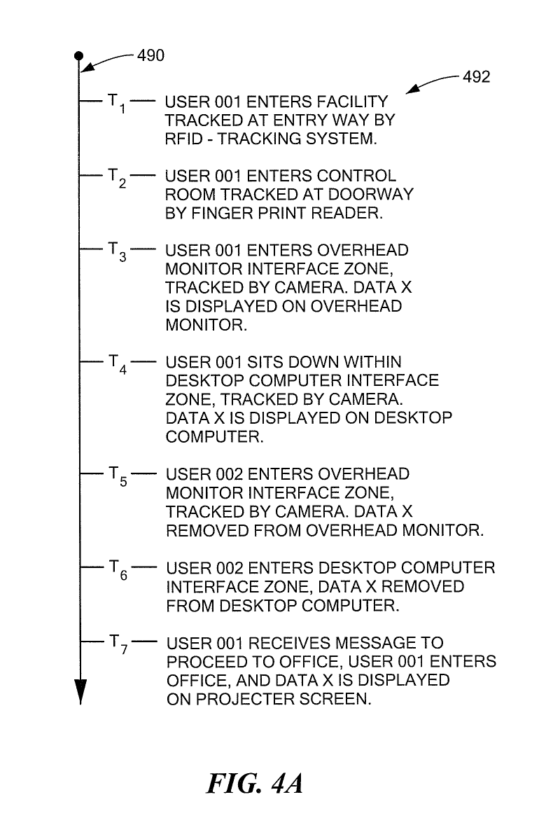

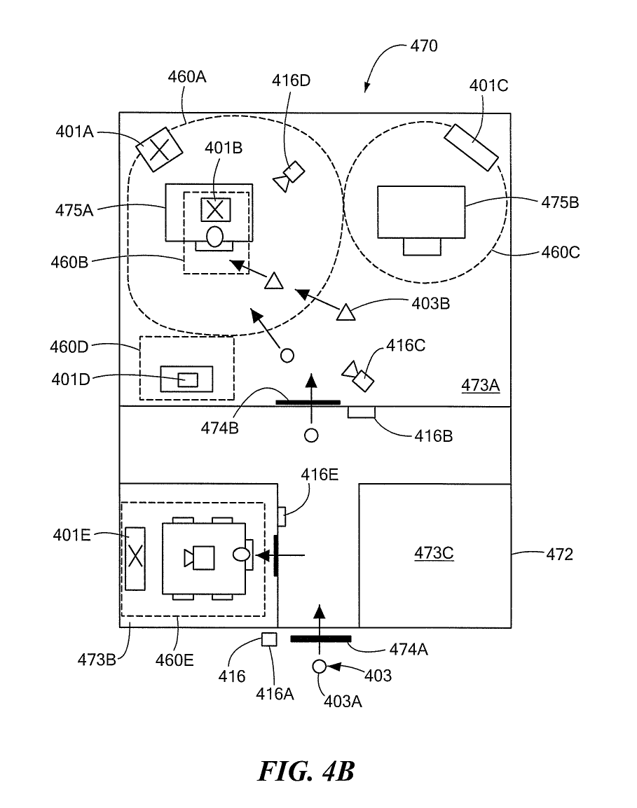

Referring now to FIGS. 4A and 4B, timeline 490 and exemplary operating environment 470 illustrate an exemplary operation of an embodiment of system 100 described in conjunction with FIG. 1. Timeline 490 includes operating events 492 of system 100. Operating environment 470 includes a facility 472 having first room 473A, second room 473B, third room 473C, door 474A leading into facility 472, and door 474B leading into room 473A. Room 473A includes equipment to control and monitor operations and includes control consoles 475A, 475B and devices 401A, 401B, 401C, 401D, each defining respective interface zones 460A, 460B, 460C, 460D. Room 473B is used as a meeting office and includes tables and chairs and device 401E defining interface zone 460E.

Facility 472 includes sensors and identification devices 416, such as facility entryway sensor 416A, room 473A entryway sensor 416B, camera tracker 416C, camera tracker 416D, and room 473B entryway sensor 416E. Sensors and identification devices 416 track and monitor users 403 as they move about facility 472, e.g., as users 403 enter and exit rooms 473A, 473B, 473C and enter and exit interface zones 460A-E. Users 403 include first user 403A denoted in FIG. 4B by a circle and hereinafter referred to as “USER 001” and second user 403B denoted in FIG. 4B by a triangle and hereinafter referred to as “USER 002.” USER 001 and USER 002 share facility 472 to conduct and monitor various tasks and operations. USER 001 is particularly interested in data “X” and has permission to access data X, however, USER 002 does not have permission to access data X.

At time T1 on timeline 490, USER 001 enters facility 472 and is tracked at entryway sensor 416A which includes a radio frequency identification (RFID) system to detect an RFID tag worn by and used to identify user 403A. At time t2, USER 001 enters control room 473A and is tracked at entryway sensor 416B which includes a facial recognition scanner and/or a finger print scanner to identify user 403A. At time T3, USER 001 enters interface zone 460A defined about device 401A which includes an overhead monitor. Camera tracker 416C tracks user 403A entering interface zone 460A and renders tracking information to a tracking system and/or a user information manager (as may be the same or similar to user information manager 140 described in conjunction with FIG. 1) which authenticates USER 001. The user information manager 140 sends user profiles which include user permissions for data access to device permissions manager (as may be the same or similar to device permissions manager 110 described in conjunction with FIG. 1). The device permissions manager compares user permissions (as may be the same or similar to user permissions 106) and enables data access on device 401A (more particularly, controls device 401A to display data X). At time T4, USER 001 enters interface zone 460B defined about device 401B which includes a desktop computer. Camera tracker 416D tracks USER 001 entering interface zone 460B and renders tracking information to the tracking system and/or the user information manager which sends user profiles and permissions for data access to the device permissions manager. The device permissions manager compares user permissions which enables data access on device 401B (more particularly, controls device 401B to display data X).

At time T5, USER 002 enters interface zone 460A as tracked by camera tracker 416C. Device permissions manager compares user permissions for USER 001 and USER 002 (in other words, data access permissions for all the users 403 located within interface zone 460A), and determines that USER 002 (i.e., at least one of the users 403 located within interface zone 460A) is unable to access data X and disables data access on device 401A (more particularly, controls device 401A to remove data X from monitor). At time T6, USER 002 enters interface zone 460B as tracked by camera tracker 416D. Device permissions manager compares user permissions for USER 001 and USER 002 (in other words, data access permissions for all the users 403 located within interface zone 460B), and determines that USER 002 (i.e., at least one of the users 403 located within interface zone 460B) is unable to access data X and disables data access on device 401B (more particularly, controls device 401B to remove data X from display).

As can be seen in FIGS. 4A and 4B, certain predetermined conditions may trigger user profiles and/or updates to user profiles to be sent to the device permissions manager. For example, predetermined conditions may correspond to users entering and/or exiting user interface zones. In other embodiments, such as those described in conjunction with FIG. 3C, predetermined conditions for sending user profiles to the device permission manager correspond to devices falling inside and/or outside user interface zones defined about users, such as may occur when users move about an environment.

In a further embodiment, at time T7, USER 001 receives a message to proceed to office 473B. Entryway sensor 416E tracks USER 001 entering office 473B all of which defines interface zone 460E about device 401E which includes a projection system. Device permissions manager enables display of data X on device 401E.

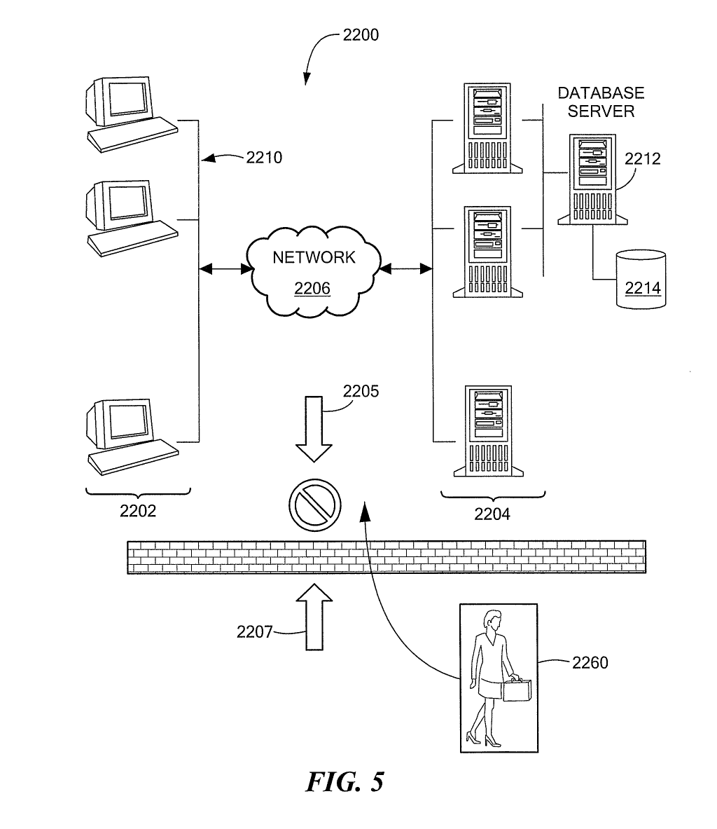

FIG. 5 illustrates a client-server environment 2200 for supporting the operation of an embodiment of the inventive systems, concepts, and techniques described herein. Client computers 2202 are coupled to server computers 2204 via a network 2206. Server computers 2204 execute device permissions managers (each of which may be the same or similar to device permissions manager 110 described in conjunction with FIG. 1) and access structured data stored in databases 2214 (as may be the same or similar to databases 151 described in conjunction with FIG. 1) on database servers 2212. Server computers 2204 receive user permissions (as may be the same or similar to user permissions 106 described in conjunction with FIG. 1), generate comparisons of user permissions and, based on the comparisons, render information 2210 to client computers 2202 (as may be the same or similar to devices 101 described in conjunction with FIG. 1) via network 2206 to control data access to users on client computers 2202. In response, client computers 2202 render data in an appropriate format to client users, for example, using a web client or other client computer-readable modules.

In a further embodiment, network 2206 is private network protected from networks outside the client-server environment 2200, such as the Internet. Optionally, a firewall may be used to control data communications between network 2206 and outside networks and to prevent unauthorized access to network 2206. In some embodiment, access to data on network 2206 (as denoted by arrow designated by reference numeral 2205) is restricted and/or blocked, whereas access to data outside network 2206 (as denoted by arrow designated by reference numeral 2207) is permitted so that client users can receive outside information such as electronic mail messages, software updates, and data files. In other embodiments, courier 2260 carries external information from outside networks to private network 2206.

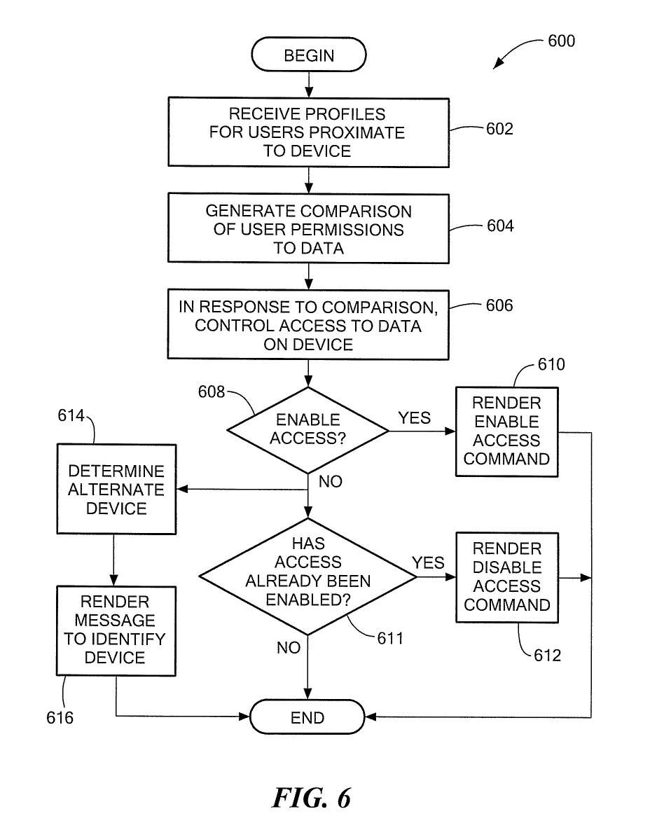

Referring now to FIG. 6, a method 600 for controlling data access on a device includes, at 602, receiving user profiles corresponding to users in proximity to the device including user permissions to data, at 604, generating a comparison of the user permissions to determine data access on the device, and, at 606, controlling access to data on the device in response to the comparison of user permissions. In a further embodiment, at 608, if data access is to be enabled, then controlling data access to the device includes rendering a command to enable data access on the device. At 608, if data access is to be disabled, then controlling data access to the device includes, at 612, rendering a command to disable data access on the device if, at 611, if data access has already been enabled.

In another embodiment, the method 600 includes, at 614, determining another device at which to enable data access and, at 616, rendering a message to identify the other device, which may include rendering a message to a user having permission to access the data.

In a further embodiment, an interface zone is defined about the device to determine whether or not users are proximate to the device and the method 600 includes receiving user profile updates based on a predetermined condition corresponding one or more users entering the interface zone about the device or exiting the interface zone about the device.

In another embodiment, an interface zone is defined about each user, proximity to the device is based on whether or not the device is located within one or more interface zones about respective one or more users, and the method 600 includes receiving user profile updates based on a predetermined condition corresponding the device location relative to at least one of the interface zones.

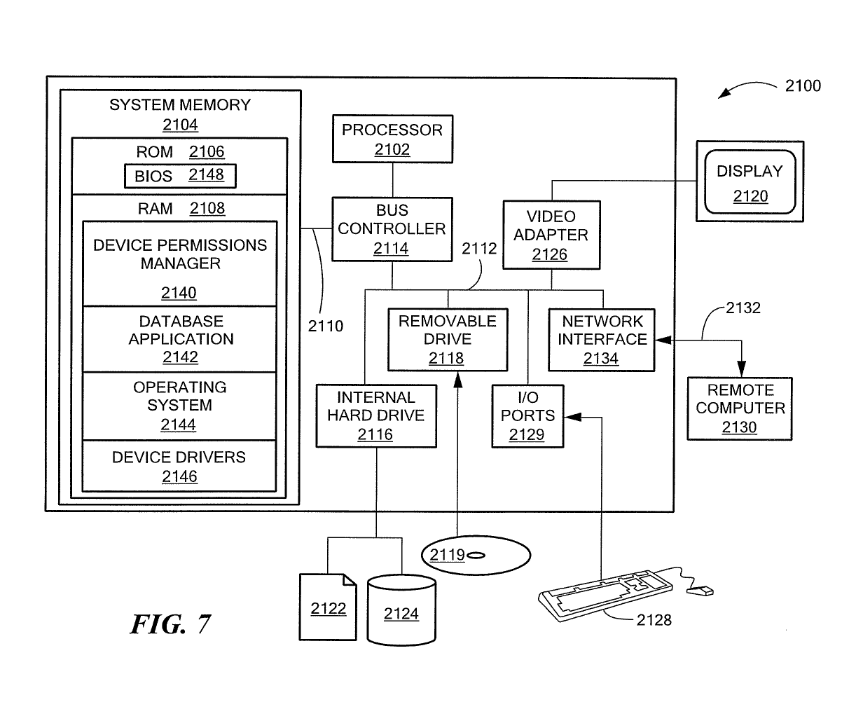

FIG. 7 illustrates a computer 2100 suitable for supporting the operation of an embodiment of the inventive systems, concepts, and techniques described herein. The computer 2100 includes a processor 2102, for example, a desktop processor, laptop processor, server and workstation processor, and/or embedded and communications processor. As by way of a non-limiting example, processor 2102 may include an Intel® Core™ i7, i5, or i3 processor manufactured by the Intel Corporation of Santa Clara, Calif. However, it should be understood that the computer 2100 may use other microprocessors. Computer 2100 can represent any server, personal computer, laptop, or even a battery-powered mobile device such as a hand-held personal computer, personal digital assistant, or smart phone.

Computer 2100 includes a system memory 2104 which is connected to the processor 2102 by a system data/address bus 2110. System memory 2104 includes a read-only memory (ROM) 2106 and random access memory (RAM) 2108. The ROM 2106 represents any device that is primarily read-only including electrically erasable programmable read-only memory (EEPROM), flash memory, etc. RAM 2108 represents any random access memory such as Synchronous Dynamic Random Access Memory (SDRAM). The Basic Input/Output System (BIOS) 2148 for the computer 2100 is stored in ROM 2106 and loaded into RAM 2108 upon booting.

Within the computer 2100, input/output (I/O) bus 2112 is connected to the data/address bus 2110 via a bus controller 2114. In one embodiment, the I/O bus 2112 is implemented as a Peripheral Component Interconnect (PCI) bus. The bus controller 2114 examines all signals from the processor 2102 to route signals to the appropriate bus. Signals between processor 2102 and the system memory 2104 are passed through the bus controller 2114. However, signals from the processor 2102 intended for devices other than system memory 2104 are routed to the I/O bus 2112.

Various devices are connected to the I/O bus 2112 including internal hard drive 2116 and removable storage drive 2118 such as a CD-ROM drive used to read a compact disk 2119 or a floppy drive used to read a floppy disk. The internal hard drive 2116 is used to store data, such as in files 2122 and database 2124. Database 2124 includes a structured collection of data, such as a relational database. A display 2120, such as a cathode ray tube (CRT), liquid-crystal display (LCD), etc. is connected to the I/O bus 2112 via a video adapter 2126.

A user enters commands and information into the computer 2100 by using input devices 2128, such as a keyboard and a mouse, which are connected to I/O bus 2112 via I/O ports 2129. Other types of pointing devices that may be used include track balls, joy sticks, and tracking devices suitable for positioning a cursor on a display screen of the display 2120.

Computer 2100 may include a network interface 2134 to connect to a remote computer 2130, an intranet, or the Internet via network 2132. The network 2132 may be a local area network or any other suitable communications network.

Computer-readable modules and applications 2140 and other data are typically stored on memory storage devices, which may include the internal hard drive 2116 or the compact disk 2119, and are copied to the RAM 2108 from the memory storage devices. In one embodiment, computer-readable modules and applications 2140 are stored in ROM 2106 and copied to RAM 2108 for execution, or are directly executed from ROM 2106. In still another embodiment, the computer-readable modules and applications 2140 are stored on external storage devices, for example, a hard drive of an external server computer, and delivered electronically from the external storage devices via network 2132.

The computer-readable modules 2140 include compiled instructions for implementing embodiments directed to controlling data access to users at the user interface level as described herein and/or as a data access component of a context-aware system. In a further embodiment, the computer 2100 may execute embodiments on one or more processors. For example, a first processor executes a device permissions comparator to receive user profiles and compare user permissions (as may be the same or similar to device permissions comparator 120, user profiles 105, user permissions 106, and comparisons described in conjunction with FIG. 1) and a second processor executes a device access controller to control access to data by rendering commands to one or more devices (as may be the same or similar to device access controller 130, command information 108, and devices 101 described in conjunction with FIG. 1). Furthermore, the first and second processors may be respective processors of a dual-core processor. Alternatively, the first and second processor may respective first and second computing devices.

The computer 2100 may execute a database application 2142, such as Oracle™ database from Oracle Corporation, to model, organize, and query data stored in database 2124. The data may be used by the computer-readable modules and applications 2140 and information associated with the data (e.g., user information, device information, command information, etc.) may be rendered over the network 2132 to a remote computer 2130 and other systems.

In general, the operating system 2144 executes computer-readable modules and applications 2140 and carries out instructions issued by the user. For example, when the user wants to execute a computer-readable module 2140, the operating system 2144 interprets the instruction and causes the processor 2102 to load the computer-readable module 2140 into RAM 2108 from memory storage devices. Once the computer-readable module 2140 is loaded into RAM 2108, the processor 2102 can use the computer-readable module 2140 to carry out various instructions. The processor 2102 may also load portions of computer-readable modules and applications 2140 into RAM 2108 as needed. The operating system 2144 uses device drivers 2146 to interface with various devices, including memory storage devices, such as hard drive 2116 and removable storage drive 2118, network interface 2134, I/O ports 2129, video adapter 2126, and printers.

Having described preferred embodiments which serve to illustrate various concepts, structures and techniques which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

What is claimed is:

1. A system, comprising:
a device permissions manager to manage user access to data on a device, comprising:
a device permissions comparator configured to receive a plurality of user profiles, each user profile corresponding to a user in proximity to the device and comprising user permissions to the data, and to generate a comparison of the user permissions; and
a device access controller configured to control access to the data on the device in response to the comparison of the user permissions.

2. The system of claim 1, wherein user proximity to the device corresponds to users located within an interface zone about the device.

3. The system of claim 2, wherein the device permissions manager is configured to receive user profile updates based on a predetermined condition corresponding to at least one of: a user entering the interface zone about the device or a user exiting the interface zone about the device.

4. The system of claim 1, wherein user proximity to the device corresponds to the device being located within at least one interface zone defined about each user.

5. The system of claim 4, wherein the device permissions manager is configured to receive user profile updates based on a predetermined condition corresponding to a device location relative to the at least one interface zone.

6. The system of claim 1, wherein the device includes a plurality of devices.

7. The system of claim 6, wherein the plurality of devices is located in a predetermined location.

8. The system of claim 6, wherein the plurality of devices is associated with a predetermined device type.

9. The system of claim 1, wherein the device permissions manager is unable to extract user identification information from the plurality of user profiles.

10. A method for controlling data access on a device, comprising:
receiving a plurality of user profiles, each user profile corresponding to a user in proximity to a device and comprising user permissions to data;
generating a comparison of user permissions to determine data access on the device; and
in response to the comparison of user permissions, controlling access to data on the device.

11. The method of claim 10, further comprising:
determining user proximity to the device based on users located within an interface zone about the device.

12. The method of claim 11, wherein receiving a plurality of user profiles comprises:
receiving user profile updates based on a predetermined condition corresponding to at least one of a user entering the interface zone about the device or a user exiting the interface zone about the device.

13. The method of claim 10, further comprising:
determining user proximity to the device based on the device being located within interface zones defined about each user.

14. The method of claim 13, wherein receiving a plurality of user profiles comprises:
receiving user profile updates based on a predetermined condition corresponding to a device location relative to at least one of the interface zones.

15. The method of claim 10, wherein the device includes a plurality of devices.

16. The method of claim 15, wherein the plurality of devices is located in a predetermined location.

17. The method of claim 15, wherein the plurality of devices is associated with a predetermined device type.

18. A computer readable medium having encoded thereon software for controlling access to data, said software comprising instructions for:
receiving a plurality of user profiles, each user profile corresponding to a user in proximity to a device and comprising user permissions to data;
generating a comparison of user permissions to determine data access on the device; and
in response to the comparison of user permissions, controlling access to data on the device.

19. The computer readable medium of claim 18, said software further comprising instructions for:
determining user proximity to the device based on users located within an interface zone about the device.

20. The computer readable medium of claim 18, wherein receiving a plurality of user profiles comprises:
receiving user profile updates based on a predetermined condition corresponding to at least one of a user entering the interface zone about the device or a user exiting the interface zone about the device.

21. The computer readable medium of claim 18, said software further comprising instructions for:
determining user proximity to the device based on the device being located within interface zones defined about each user.

22. The computer readable medium of claim 21, wherein receiving a plurality of user profiles comprises:
receiving user profile updates based on a predetermined condition corresponding to a device location relative to at least one of the interface zones.

23. The computer readable medium of claim 18, wherein the device includes a plurality of devices.

24. The computer readable medium of claim 23, wherein the plurality of devices is located in a predetermined location.

25. The system of claim 23, wherein the plurality of devices is associated with a predetermined device type.
